(19) United States
(12) Patent Application Publication
(10) Pub. No.: US 2019/0144180 A1
(43) Pub. Date: May 16, 2019

(54) STADIUM TRAY

(71) Applicant: Menasha Corporation, Neenah, WI (US)

(72) Inventors: William J. Mertz, II, Greensburg, PA (US); Brad L. Clark, North Huntingdon, PA (US)

(21) Appl. No.: 16/185,655

(22) Filed: Nov. 9, 2018

Related U.S. Application Data
(60) Provisional application No. 62/585,938, filed on Nov. 14, 2017.

(51) Int. Cl. B65D 71/58; B65D 5/02; B65D 5/468; B65D 5/48; B31B 50/26

(52) U.S. Cl. CPC B65D 71/0022; B65D 5/0254; B65D 5/4608; B65D 5/48014; B31B 2100/00; B65D 2571/0045; B65D 2571/0066; B65D 2571/00253; B31B 50/26

(57) ABSTRACT

The present invention provides a tray for carrying both food and drinks. The tray includes a food compartment having a bottom wall, a first side wall, a second side wall, a back wall, and a top wall moveable from a closed position to an open position. The food compartment can be enclosed to keep the food warm. A handle can be formed in the food compartment. A cup holder portion is connected to the food compartment for holding a plurality of cups containing liquid.

### CROSS-REFERENCE TO RELATED APPLICATIONS

The present invention claims priority to and the benefit of U.S. Provisional Patent Application No. 62/585,938 filed Nov. 14, 2017, the contents of which are incorporated herein by reference.

### FEDERALLY SPONSORED RESEARCH OR DEVELOPMENT

N/A

### FIELD OF THE INVENTION

The present invention is generally directed to a foldable food tray which can be used at concession stands at an entertainment venue such as, for example, a sporting event in a stadium or arena.

### DESCRIPTION OF THE PRIOR ART

A number of different trays and containers are used at concession stands for carrying drinks and food. A large number of such trays (sometimes referred to as “stadium trays”) are used at events at large stadiums or arenas (e.g., sporting events, concerts, etc.). Existing carriers are typically fiberboard. The carriers are usually open and can hold two to four cups and food (in a center or end portion). Such carriers typically require being held with two hands, especially when full, and do not include handles.

The present invention provides an improved stadium tray for carrying drinks and food.

### SUMMARY OF THE INVENTION

The present invention provides a carrier or tray having a one piece design constructed from a corrugated paper material, such as EXT 23 E Flute. The tray is die-cut to form a single blank of material having the appropriate sized flaps, panels and scores. Portions of the blank can be glued before shipping to the stadiums or other venues to reduce set up time at the concession stand.

The resulting tray includes a food compartment, a handle and a drink holder. The bottom of the tray is formed to have a crash-lock (sometimes referred to as a multi-point carton). The crash-lock includes one or more flaps or other portions of tray (e.g., the seam) being glued together prior to shipment in a flat configuration. When the flat, shipped blank is opened or unfolded, the glued portions cause the bottom to automatically erect. That is, the base of the tray folds out and clicks into place—no additional taping or sealing is needed.

A handle is created from flaps that are used to enclose a food compartment. The top of the food compartment has a lock to stop the top from opening and gives the handle additional strength

The present tray will reduce the set-up time and thus the time spent at a concession stand. It provides a rigid container that supports several food items and drinks. The tray also maintains food quality and temperature.

In accordance with one aspect of the invention, a tray is provided for carrying both food and drinks. The tray comprises an enclosed food compartment and a cup holder connected to the enclosed food compartment. The enclosed food compartment includes a handle formed in a front wall portion of the enclosed food compartment.

The food compartment includes a rectangular bottom wall, a first side wall, a second side wall, a back wall and a top wall. The top wall can be formed from a flap connected to a top edge of the back wall. The top wall of the food compartment can include a front wall portion. The front wall portion of the food compartment can include a handle opening.

The cup holder can include a bottom wall connected to the bottom wall of the food compartment, a first side wall connected to the first side wall of the food compartment, a second side wall connected to the second side of the food compartment and a cup holder front wall. The cup holder can also include a cup holder top wall having a plurality of openings for inserting cups and a cup holder back wall connected to the cup holder top wall. Each of the plurality of openings in the cup holder can include a plurality of tabs extending into the openings.

In accordance with another aspect of the present invention, a tray for carrying food and drinks comprises a food compartment having a bottom wall, a first side wall, a second side wall, a back wall, and a top wall moveable from a closed position to an open position. The tray also includes a handle formed in the food compartment and a cup holder portion connected to the food compartment.

The tray can further include a front wall portion in the food compartment. The handle can be formed in the front wall portion of the food compartment. Additionally, the front wall portion can include a first side tab for connecting to the first side wall and a second side tab for connecting to the second side wall. The first side wall can include a first slot for receiving a portion of the first tab and the second side wall can include a second slot for receiving a portion of the second tab.

The cup holder portion can include a top wall having a plurality of cup openings. The top wall can be formed from a first flap connected to the first side wall, a second flap connected to the second side wall and a third flap connected to the back wall. The cup holder portion can also include a back wall separating the cup holder portion from the food compartment.

In any aspect of the tray, the food compartment and the cup holder portion can be formed from a corrugated paper material, corrugated plastic or other similar or suitable materials. Moreover, the tray can be formed from a single blank of the corrugated paper material.

Other features of the tray are described herein and are shown in the Figures and attachments.

### BRIEF DESCRIPTION OF THE DRAWINGS

To understand the present invention, it will now be described by way of example, with reference to the accompanying drawings in which:

FIG. 1 is a front perspective view of a tray (with cups) for holding food and drinks in accordance with the present invention;

FIG. 2 is a rear perspective view of the tray of FIG. 1 (without cups);

FIG. 3 is a front perspective view of the tray of FIG. 2 with flaps for the food compartment open;

FIG. 4 is a rear perspective view of the tray of FIG. 3;

FIG. 5 is a front perspective view of the tray of FIGS. 3 and 4 with two of the food compartment's flaps folded;

FIG. 6 is a perspective view of a customer holding the tray of FIG. 1;

FIG. 7 is a plan view of a blank for forming the tray of FIG. 1;

FIG. 8 is a perspective view of the tray of FIG. 1 with all of the flaps unfolded;

FIG. 9 is a perspective view of the tray of FIG. 8 with two of the flaps for forming the cup holder folded; and,

FIG. 10 is a blank for forming a tray in accordance with FIG. 1 having components for forming a stronger handle structure.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

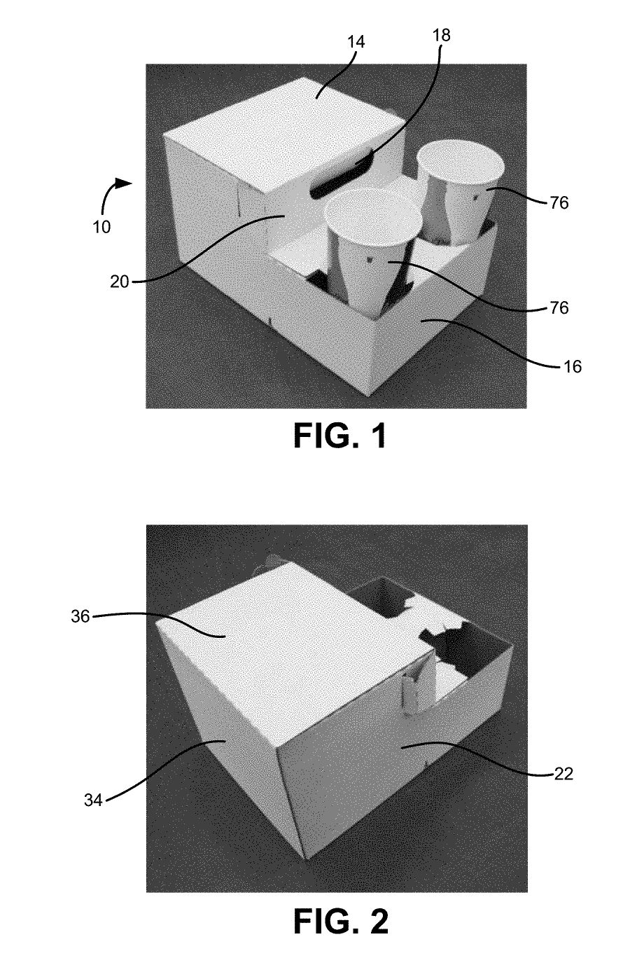

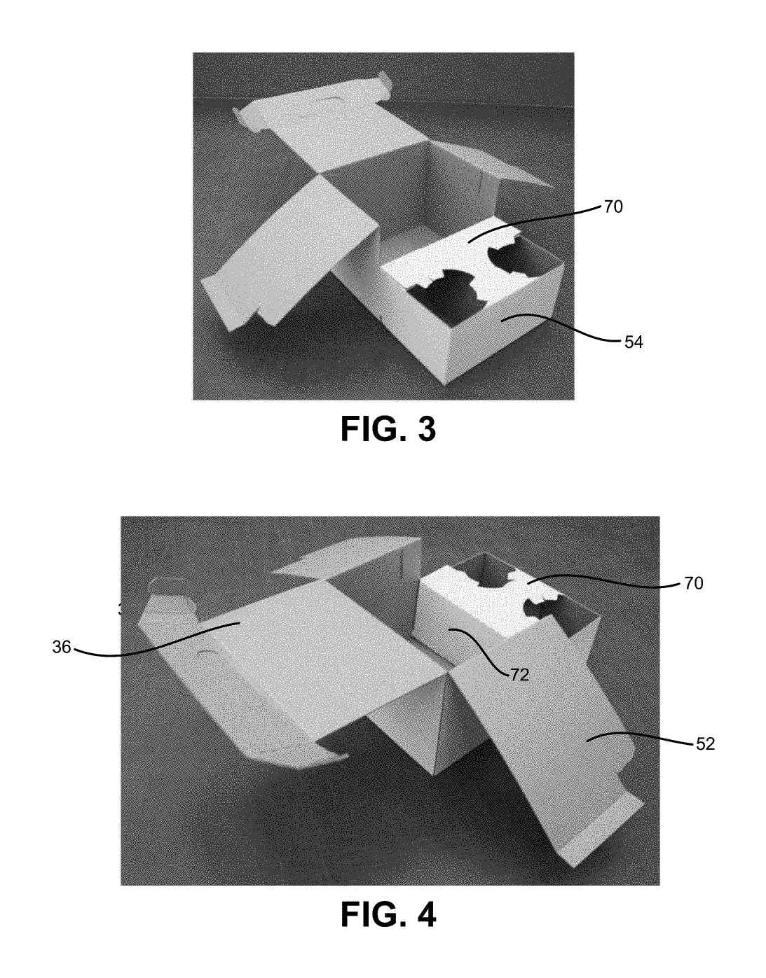

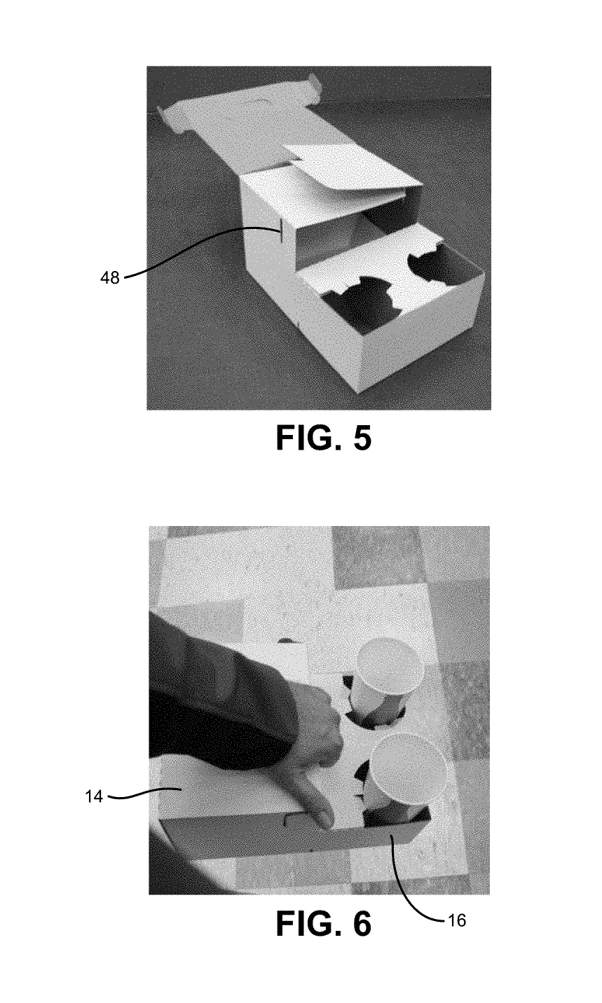

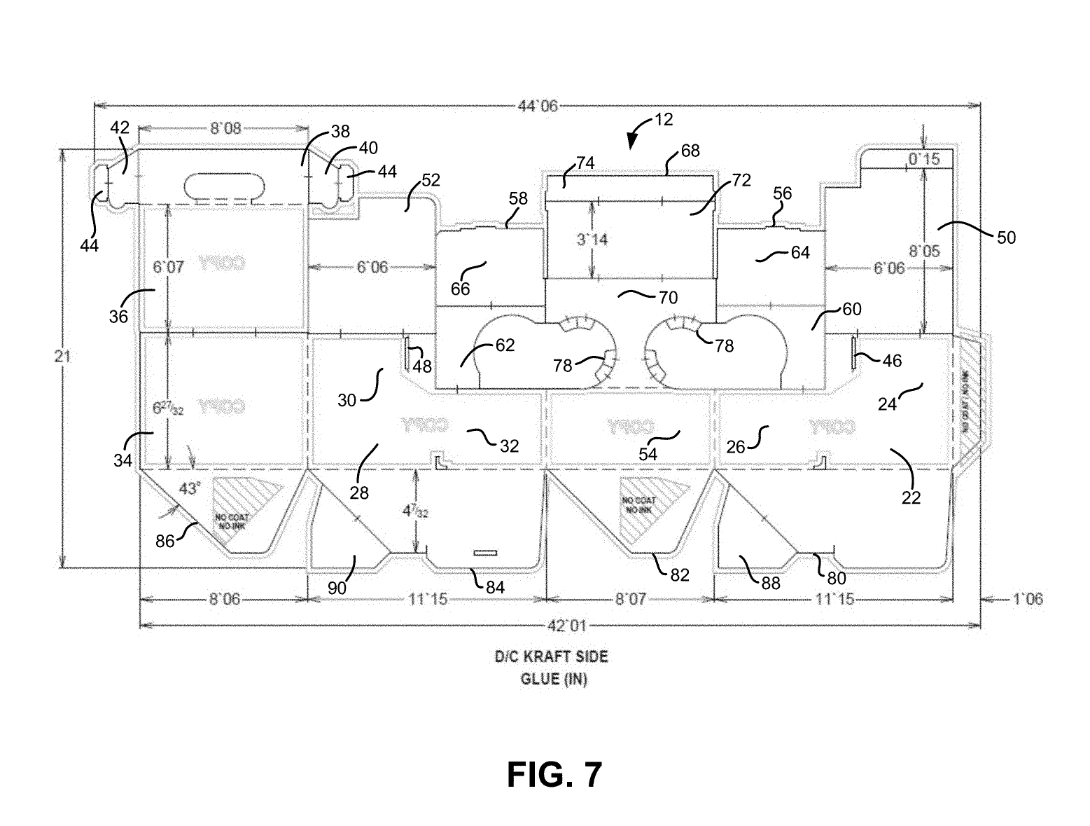

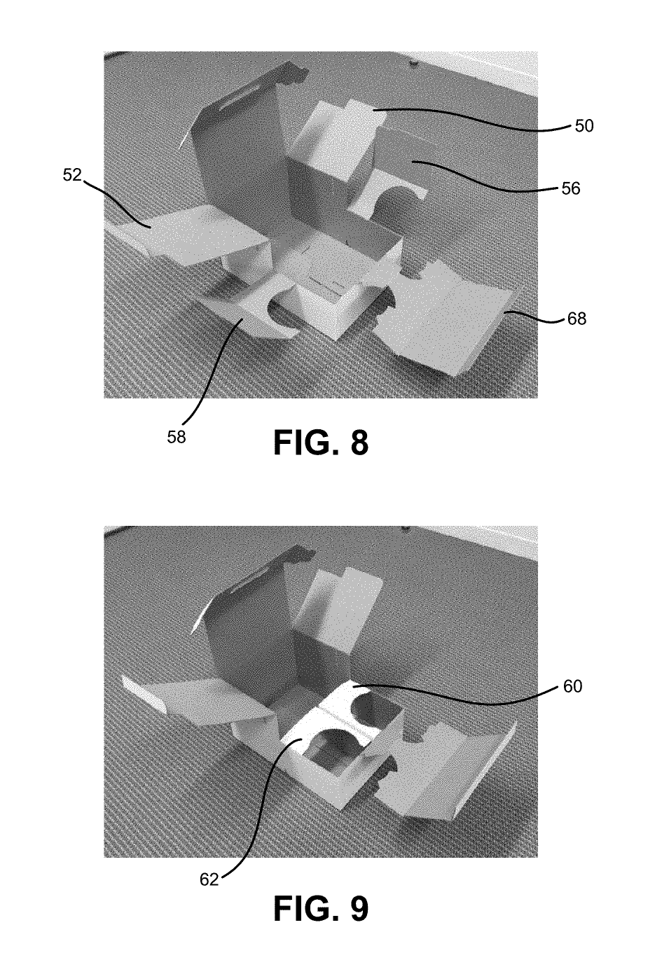

An embodiment of a tray 10 for carrying both food and drinks is shown in FIGS. 1-6 and 8-9. FIG. 7 shows a blank 12 for forming the tray 10.

As shown in FIG. 1, the tray 10 includes a box-like, enclosed food compartment 14 and a cup holder portion 16. A handle 18 is formed in a front wall portion 20 of the food compartment 14 in the middle of the tray 10.

The tray includes a first side wall 22, having a first side wall portion 24 for the food compartment 14 and a second side wall portion 26 for the cup holder portion 16. The first side wall portion 24 has a greater height than the second side wall portion 26. The tray 10 also includes an identical second side wall 28 having a first side wall portion 30 and a second side wall portion 32. Again, the height of the first side wall portion 30 of the second side wall 28 is greater than the height of the second side wall portion 32. This height difference is provided to accommodate the positioning of the handle 18 in the middle of the tray 10.

The tray includes a back wall 34 (which also forms the back wall of the food compartment 14). The back wall 34 is connected to a top wall 36 for the food compartment 14. In turn, the top wall 36 is connected to a flap 38 that is folded downward to partially form a front wall for the upper part of the food compartment 14. The handle 18 is formed in the partial front wall flap 38. The partial front wall flap 38 also includes a first side tab 40 and a second side tab 42. The first and second side tabs 40, 42 each include a portion 44 that can be received in first and second slots 46, 48 on the first side wall portions 24, 30 of the first and second side walls 22, 28.

Each of the first side wall portions 24, 30 of the first and second side walls 22, 28 are connected to a top flap 50, 52. The top flaps 50, 52 are part of the food compartment 14 and are folded over prior to folding of the top wall 26.

The tray 10 includes a front wall 54. This front wall 54 of the tray 10 also forms a front wall of the cup holder portion 16.

The second side wall portions 26, 32 of the first and second side walls 22, 28 are each connected to an upper flap 56, 58. The upper flaps 56, 58 include a first partial cup holder panel 60, 62, and a second divider panel 64, 66. The cup holder panels 60, 62 include cut out portions to create openings for cups (see e.g., cups 76 in FIG. 1). The divider panels 64, 66 are folded downward and form a vertical interior wall in the cup holder portion 16 that is perpendicular to the front wall 54 (when the tray 10 is fully assembled).

The front wall 54 also includes an upper flap 68. The upper flap 68 of the front wall 54 includes a cup holder panel 70 (that is placed over the first partial cup holder panels 60, 62) and a wall panel 72. Similar to the cup holder panels 60, 62 of the flaps 56, 58, the cup holder panel 70 of flap 68 includes cut out portions to create openings for cups 76. The wall panel 72 is folded down to a position parallel to the front wall 54 on the other side of the divider panels 64, 66. The wall panel 72 includes a tab 74 that gets folded back toward the front wall 54. The wall panel 72 acts as a back wall to the cup holder portion 16, and the remainder of the front wall for the food compartment 14 (along with flap 38).

The cup holder panel 70 of flap 68 also includes a plurality of tabs 78 extending into the cup openings to assist in securing cups 76 in the cup holder portion 16. The cup holder panels 60, 62 of flaps 56, 58 could also be provided with similar tabs if desired. While the cup holder portion 16 is shown having two cup openings, it could be extended to provide additional cup holders (e.g., four, six etc.) if desired.

The tray 10 has a rectangular bottom wall formed from a plurality of flaps 80, 82, 84, 86 connected respectively to the bottom of the first side wall 22, front wall 54, second side wall 28 and back wall 34. Each of the flaps 80, 84 connected to the side walls 22, 28 include a foldable, glue-able segment 88, 90 (or after gluing—“glued” segments 88, 90). The glue-able segments 88, 90 can be pre-glued (i.e. prior to shipping and/or set-up) to flaps 82, 86, respectfully. The glued segments 88, 90—along with a glued side wall tab 92 connected to the first side wall 22 (i.e., that is glued to the back wall 34), enable the bottom of the tray 10 to automatically configure when flattened blanks are unfolded.

The blank 12 for forming the tray 10 is preferably a single piece of material. Alternatively, aspects or components of the tray can be formed from multiple pieces of material. The tray 10 can be formed from a corrugated paper material, a corrugated plastic material, paperboard, or other suitable or similar materials.

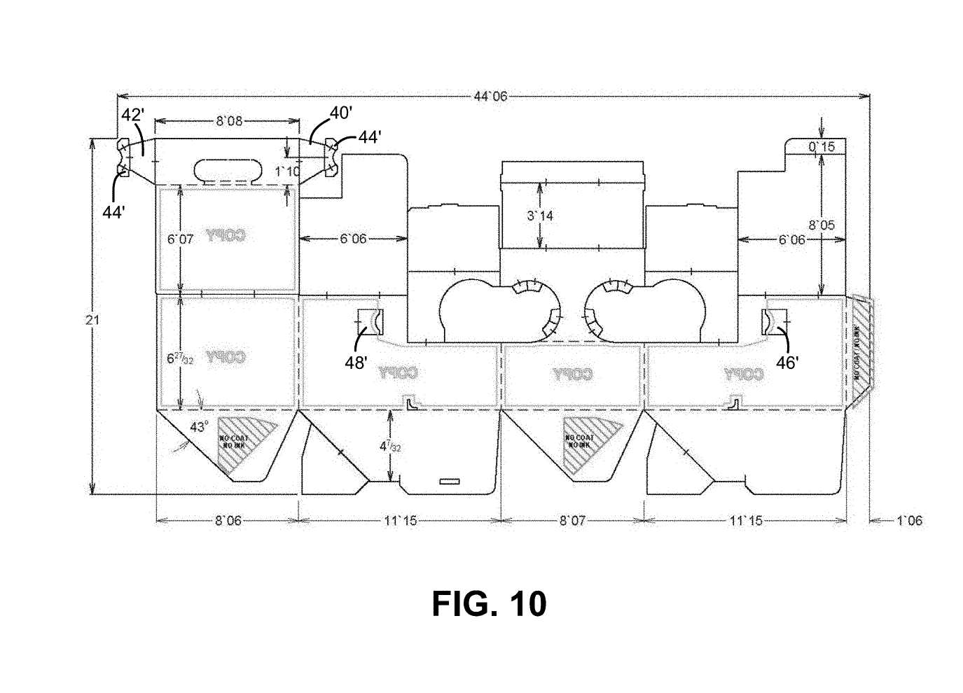

Similar to FIG. 7, FIG. 10 also shows a blank for forming a tray 10 in accordance with the present invention. The blank of FIG. 10 includes modified first and second side tabs 40′, 42′. Each of the modified first and second side tabs 40′, 42′ include a modified portion 44′. The modified portion 44′ is designed to be received in modified first and second slots 46′, 48′ on the first side wall portions of the first and second side walls. The side tabs and slots 40′, 42′, 44′, 46′ and 48′ form a more resistant lock to create a stronger handle structure in a set up tray 10.

Many modifications and variations of the present invention are possible in light of the above teachings. It is, therefore, to be understood within the scope of the appended claims the invention may be protected otherwise than as specifically described.

I claim:

1. A tray for carrying food and drinks comprising:
an enclosed food compartment; and,
a cup holder connected to the enclosed food compartment.

2. The tray of claim 1 further comprising a handle formed in the enclosed food compartment.

3. The tray of claim 2 wherein the food compartment includes a rectangular bottom wall, a first side wall, a second side wall, a back wall and a top wall.

4. The tray of claim 3 wherein the top wall is formed from a flap connected to a top edge of the back wall and wherein the top wall of the food compartment includes a front wall portion.

5. The tray of claim 4 wherein the front wall portion of the food compartment includes a handle.

6. The tray of claim 2 wherein the cup holder includes a bottom wall connected to the bottom wall of the food compartment, a first side wall connected to the first side wall of the food compartment, a second side wall connected to the second side of the food compartment and a cup holder front wall.

7. The tray of claim 6 further comprising a cup holder top wall having a plurality of openings for inserting cups and a cup holder back wall connected to the cup holder top wall.

8. The tray of claim 7 wherein each of the plurality of openings in the cup holder include a plurality of tabs extending into the openings.

9. The tray of claim 1 wherein the cup holder and food compartment are formed from a corrugated paper material.

10. The tray of claim 9 wherein the tray is formed from a single blank of the corrugated paper material.

11. A tray for carrying food and drinks comprising:
a food compartment having a bottom wall, a first side wall, a second side wall, a back wall, and a top wall moveable from a closed position to an open position;
a handle formed in the food compartment; and,
a cup holder portion connected to the food compartment.

12. The tray of claim 11 further comprising a front wall portion in the food compartment.

13. The tray of claim 12 wherein the handle is formed in the front wall portion of the food compartment.

14. The tray of claim 12 wherein the front wall portion includes a first side tab for connecting to the first side wall and a second side tab for connecting to the second side wall.

15. The tray of claim 14 wherein the first side wall includes a first slot for receiving a portion of the first tab and the second side wall includes a second slot for receiving a portion of the second tab.

16. The tray of claim 11 wherein the cup holder portion includes a top wall having a plurality of cup openings.

17. The tray of claim 16 wherein the cup holder portion includes a back wall separating the cup holder portion from the food compartment.

18. The tray of claim 11 wherein the top wall is formed from a first flap connected to the first side wall, a second flap connected to the second side wall and a third flap connected to the back wall.

19. The tray of claim 11 wherein the food compartment and the cup holder portion are formed from a corrugated paper material.

20. The tray of claim 19 wherein the tray is formed from a single blank of the corrugated paper material.
